(19) United States
(12) Patent Application Publication
(10) Pub. No.: US 2014/0264194 A1
(43) Pub. Date: Sep. 18, 2014

(54) In-Situ Synthesis of Multi-Core Core Electoconductive Powders

(71) Applicant: Milliken & Company, Spartanburg, SC (US)

(72) Inventors: Emily W. Michaels, Taylors, SC (US); Deanna Milligan, Boiling Springs, SC (US); David Morris, Duncan, SC (US)

(73) Assignee: Milliken & Company, Spartanburg, SC (US)

(21) Appl. No.: 14/207,772

(22) Filed: Mar. 13, 2014

Related U.S. Application Data
(60) Provisional application No. 61/802,805, filed on Mar. 18, 2013.

(51) Int. Cl. H01B 1/08

(52) U.S. Cl. CPC H01B 1/08
USPC 252/519.33; 252/520.1

(57) ABSTRACT

This invention relates to the in-situ synthesis of multi-core electroconductive powders. The multi-core ECPs of the present invention are made using an in-situ synthesis method which eliminates the need for combining mixtures of various types of single-core ECPs in order to achieve the desired end-use product. The multi-core ECPs described herein exhibit very little coloration. They also exhibit low electrical resistivity and contain reduced amounts of antimony.

### CROSS-REFERENCE TO RELATED APPLICATIONS

This application claims priority to U.S. Patent Application Ser. No. 61/802,805, entitled “In-Situ Synthesis of Multi-Core Electroconductive Powders,” which was filed on Mar. 18, 2013, and which is entirely incorporated by reference herein.

### TECHNICAL FIELD

This invention relates to the in-situ synthesis of multi-core electroconductive powders.

### BACKGROUND

Electroconductive powders, in general, and those comprising antimony-containing tin oxide and using such powders for imparting electroconductive properties to a wide variety of surfaces, are known generally to the art. Electroconductive powders (“ECP” or “ECPs”), or more specifically Polytype ECPs (hereinafter referred to as “PECP” or “PECPs”) comprise mixtures of several types of ECPs. Mixtures of PECP tend to possess a lower electrical resistivity, or a higher electroconductivity, than would be expected from the weighted average of the component ECP. PECPs are multi-component and may contain many different types of ECPs. Binary or ternary mixtures are normally preferred.

ECPs may contain a single core of, for example, oxides of titanium. PECPs are a mixture of these single core ECPs. As a result, one disadvantage of using these prior art PECPs is that multiple batches of different materials need to be made, which results in potential lot-to-lot variation, as well as increased manufacturing time.

Accordingly, the need exists for an improved ECP that exhibits all of the functional features of the prior art, while reducing the undesirable batch-to-batch inconsistencies and manufacturing complications pertaining thereto.

Thus, the present invention provides a new electroconductive powder that contains a dual core of shaped particles upon which amorphous silica is deposited thereon. The dual-core ECPs of the present invention are made using an in-situ synthesis method which eliminates the need for combining mixtures of various types of single-core ECPs in order to achieve the desired end product, e.g. exhibiting very little coloration, having low electrical resistivity, containing lower amounts of antimony, and the like.

### BRIEF SUMMARY

This invention relates to an in-situ synthesized, multi-core electroconductive composition comprising at least two core materials. The at least two core materials are independently selected from the group consisting of mica; silica; calcium carbonate; oxides of titanium, magnesium, calcium, barium, strontium, zinc, tin, nickel and iron; barium carbonate; strontium carbonate; calcium sulfate; barium sulfate; strontium sulfate, cordierite; anorthite; and pyrophyllite.

### BRIEF DESCRIPTION OF THE DRAWINGS

FIG. 1A is a photomicrograph of manually blended ECP-T and ECP-S.

FIG. 1B is a composite gas chromatography scan of the manually blended ECP-T and ECP-S shown in FIG. 1A.

FIG. 2A is a photomicrograph of in-situ synthesized dual core PECP (a combination of ECP-T and ECP-S).

FIG. 2B is a composite gas chromatography scan of the in-situ synthesized dual core PECP shown in FIG. 2A.

FIG. 3A is an individual gas chromatography scan of the in-situ synthesized dual core PECP for Particle A shown in FIGS. 2A and 2B.

FIG. 3B is an individual gas chromatography scan of the in-situ synthesized dual core PECP for Particle B shown in FIGS. 2A and 2B.

FIG. 3C is an individual gas chromatography scan of the in-situ synthesized dual core PECP for Particle C shown in FIGS. 2A and 2B.

FIG. 3D is an individual gas chromatography scan of the in-situ synthesized dual core PECP for Particle D shown in FIGS. 2A and 2B.

FIG. 3E is an individual gas chromatography scan of the in-situ synthesized dual core PECP for Particle E shown in FIGS. 2A and 2B.

### DETAILED DESCRIPTION

The present invention relates broadly to a new class or type of electroconductive powder that contains a dual core of shaped particles upon which amorphous silica is deposited thereon. The dual-core ECPs of the present invention are made using an in-situ synthesis method which eliminates the need for combining mixtures of various types of single-core ECPs in order to achieve the desired end product, e.g. exhibiting very little coloration, having low electrical resistivity, containing lower amounts of antimony than is present in current products, and the like.

The dual-core ECP of the present invention are synthesized in a single reaction, rather than in two or more reactions that result in separate batches of material which must be further precisely blended together. As a result, a time savings, as well as a cost savings, is realized. Additionally, the dual-core ECP of the present invention reduces and/or eliminates lot-to-lot inconsistency which results from manufacturing separate batches of ECPs and blending them into a single product. The dual-core ECP of the present invention also exhibits improved characteristics which will be discussed later.

ECP components of the PECP can be selected from at least one member of the group consisting of crystallites of tin oxide containing antimony in solid solution, crystallites of antimony-containing tin oxide with uniformly distributed amorphous silica, and two dimensional networks of crystallites of antimony-containing tin oxide in a unique association with amorphous silica or silica-containing material, metal coated powders, among others. In some cases, one or more components of the PECP can comprise conventional ECP materials such as carbon, aluminum powder, among others. When incorporated into surface coatings, films and other substrates, PECPs impart electroconductivity while using a relatively lesser amount of antimony-containing tin oxide in comparison to the amount of antimony-containing tin oxide than would be required if the individual component ECP types were used. In addition to providing a substantial economic advantage, the PECPs reduce the quantity of antimony that is present thereby minimizing color and achieving greater transparency.

In one aspect of the invention the PECP composition may comprise at least one filler particulate material, which is neither associated with antimony-containing tin oxide nor electroconductive, and at least one ECP.

In another aspect, the invention relates to a process for preparing the compositions of the invention that consists essentially of using an in-situ synthesis method which creates a multi-core ECP while maintaining the electroconductive network of the component ECPs.

In yet another aspect, the invention relates to electroconductive coatings which comprise or consist essentially of the PECP, which imparts the conductivity, and a carrier matrix or vehicle system. Examples of suitable matrices or vehicles for producing an electroconductive coating comprise at least one member from the group of paint, varnish, plastic films upon fabrics and paper, among others. In some cases, the PECP may be a component within a filled plastic, e.g., polyester, acrylics, polyethylene, polypropylene, polystyrene, nitrocellulose, nylon, among others.

While the certain individual ECP components of the PECP are known in this art, multi-core materials having properties of the PECP were heretofore unknown. For example, the PECP has a lower electrical resistivity (or higher conductivity) than would be predicted by the weighted average of the electrical resistivities for the component ECP powders, among other desirable properties. By reducing the quantity of antimony that is necessary for conductivity, the PECP solves color and transparency problems associated with conventional ECPs. Normally, the total quantity of antimony in a PECP ranges from about 0.5 to about 20% by weight.

Suitable components for preparation of PECPs can be selected from known ECP materials. The ECP composition can be a powder comprising or consisting essentially of shaped particles such as at least one member from the group of amorphous silica, inert core particles coated with amorphous silica, hollow amorphous silica shells, among others. Suitable core particles comprise at least one member from the group of oxides of titanium, magnesium, calcium, barium, strontium, zinc, tin, nickel and iron; carbonates and sulfates of calcium, barium and strontium; mica, cordierite, anorthite and pyrophyllite, among others. The primary function of the core material is providing a shaped particle upon which the amorphous silica substrate can be deposited. These types of powders and methods for their preparation are described in greater detail in U.S. Pat. No. 5,024,826 and European Patent Application Publication No. 0 359569 (corresponding to U.S. patent application Ser. No. 07/386,765), the disclosure of which have been incorporated by reference.

Powders comprising or consisting essentially of hollow shells of amorphous silica having a surface coating layer of antimony-containing tin oxide; hereinafter referred to as “ECP-S”. The average particle size for ECP-S is typically in the range of 0.5 to 15 microns and the particle shape, determined by the shape of the core material which is removed after depositing a coating of amorphous silica, can be irregularly equiaxed or acicular. Generally this type of ECP provides the highest efficiency-in-use based on the loadings required in film coatings to achieve a desired level of electroconductivity.

Powders comprising or consisting essentially of a silica coated solid core of titanium dioxide covered with a conductive coating of antimony-containing tin oxide; hereinafter referred to as “ECP-T”. The average particle size of this material is typically in the range of 0.1 to 20 microns and the particles are predominantly equiaxed. While any suitable method can be used for preparing this powder, the method described in U.S. patent application Ser. No. 07/874,878, filed on Apr. 28, 1992, hereby incorporated by reference, is particularly useful.

The ECP component powders can also comprise or consist essentially of about 0.5 to about 20 wt % amorphous SiO₂ substantially uniformly distributed with about 80 to about 99.5 wt % of crystallites of antimony-containing tin oxide, wherein the antimony component of the tin oxide ranges from between about 0.5 to about 12.5 wt %. While any suitable method can be used for preparing this powder, the method described in U.S. patent application Ser. No. 07/905,980, previously incorporated by reference, is particularly useful.

Further, one or more components of the PECP can comprise conventional ECP materials such as carbon, aluminum powder, among others. In some cases, the ECP components powders comprise or consist of hollow shells of silica having a surface coating layer comprising at least one metal selected from the group of Pd, Pt, Rh, Re, In, Au, Ag, Cu Ni, among others. These metal coated powders are described in greater detail in U.S. patent application Ser. No. 07/979,497, filed on Nov. 20, 1992; the subject matter of which is hereby incorporated by reference.

Characteristics of certain suitable component ECP powders are summarized in Table 1.

TABLE 1
ECP Components SiO₂ Coated Cores

| | “S” Version | “T” Version |
|---|---|---|
| Average Particle Size | 0.5-15 | 0.1-20 |
| (microns) | | |
| Aspect Ratio | ~1 | ~1 |
| Tapped Density (g/cc) | 0.2-0.6 | 0.9-1.3 |
| Dry Powder Resistivity | 2-30 | 2-30 |
| (ohms-cm) | | |

In another aspect of the invention one or more component powders can be particulate material which is not associated with antimony-containing tin oxide and which is not electroconductive (hereinafter referred to as a “filler”), with the limitation that at least one type of ECP powder must be a component of the PECP mixture. Powders suitable for use as a filler can comprise or consist of at least one member of amorphous silica particles, hollow silica shells, the group of core particles described previously, among others.

The PECP compositions of the invention are multi-core materials of the herein described components. By “multi-core” it is meant that the ECP core components are synthesized in-situ such that there are substantially no concentration gradients within the PECP. The core may comprise or consist essentially of binary, ternary, quaternary or multicomponent materials depending upon the desired number of different ECP types included in the synthesis. In one aspect, an individual type of ECP constitutes at least about 2 wt %, or in another aspect at least about 5 wt %, and in another aspect at least about 10 wt % of the PECP. Most preferred are binary cores. In one aspect neither core component constitutes less than about 10 wt % of the mixture. When the content of an ECP component is less than about 2 wt % its contribution to the synergistic improvement in dry powder conductivity and end-use performance may be reduced, if not eliminated. The proportions of ECP cores which are synthesized to give a PECP depend on the particular application for which the PECP is intended. Wide ranges of adjustment can be made so that a PECP can be tailored with respect to both the types of ECP and non ECP powders comprising the composition and to their proportions in order to achieve a desired combination of properties such as resistivity, transparency and degree of color or whiteness.

PECP powders are prepared by an in-situ synthesis method to obtain a multi-core material while minimizing any changes to the morphology and integrity of the individual particles. It is particularly important in the case of ECP component particles having surface coatings of antimony-containing tin oxide that the continuity of the coating not be adversely affected, e.g., disrupted, by the synthesis procedure. If the synthesis procedure is too severe these intermingling constraints are not met and the electroconductive character of the ECP component particles is adversely affected resulting in decreased performance in end-use applications thus counteracting the desirable synergistic improvement observed for PECP prepared by the multi-core synthesis procedure. On the other hand if the synthesis procedure is not sufficiently thorough the component powders are not intimately mixed and the resulting powder is inhomogeneous and very little improvement in performance is obtained, compared with the weighted average of the ECP components.

The dry powder resistance (DPR) was measured by using a cylindrical cell. The cell was constructed with brass electrodes at the top and bottom that fit snugly inside a cylindrical piece of plastic having an internal diameter of about 3 centimeters. Copper leads attached to the brass electrodes were connected to an ohm meter. With the bottom electrode in position a sample of powder was introduced into the plastic cylinder and the top electrode was placed in position above the powder. The height of the powder should be about 2.0 cm before applying pressure to the powder. Using a Carver laboratory press, the powder sample was compressed at a pressure of about 2000 psi between the upper face of the bottom electrode and the lower face of the top electrode. The height and electrical resistivity of the powder were then measured, the latter with the ohm meter.

The value of the powder resistance, at the compression used, was obtained, by the following calculation:

Resistivity=(Resistance×Area)/Height;

“Resistance” is measured in ohms,

“Area” of cylinder cross-section in square centimeters, and;

“Height” is the length between the top of the cell and the cylinder under 2000 psi compression measured in centimeters. In the case of the cell used in the following examples the area is 7.07 square centimeters. The PECP can be tailored to obtain a virtually unlimited array of resistivities; normally from about 10 micro ohm cm to about 5,000 ohm cm.

The efficiency-in-use of a PECP for imparting electroconductive properties to a coating can be ascertained by dispersing the powder into an aqueous vehicle containing a film forming binder such as an acrylic resin, e.g. “HTV” version The aqueous powder dispersion is coated onto anti-static transparency sheets (polyester layout base: A/S Poly 2 sides, clear, size: 8.5″×11″) using a wet film applicator that can form an approximately 0.003 inch thick wet film “drawdown” on the glass plate. After drying for about 14 hours, in air, the surface resistivity (S.R.) of the coating is measured using a commercially available milli-to-2 ohmeter (Dr. Thiedig Corp) and a Model 803A surface/volume resistivity probe (Monroe Electronics Inc., Lyndonville, N.Y.). These instruments give direct readings in ohms per square. The lower the value of S.R. the higher the electroconductivity of the film. The surface loading of powder is determined by weighing the transparency sheet prior to and after coating, then multiplying the weight difference by the percentage of powder in the coating film and dividing by the area coated. The surface loading is conventionally expressed in pounds per 1000 square feet of surface, (lbs/Kft2). The drawn PECP containing films of the invention typically have a DPR that ranges from about 1×10³ to about 1×10¹² ohms/square.

The method that was used for measuring whiteness/brightness corresponds to the procedure that is conventionally used with a Hunter Labscan Model S.100 colorimeteric. It is a colorimetric measurement, known as the L*a*b* procedure, which utilizes a Hunter Labscan Model 5100 colorimeter. This generates numerical values for L*, a* and b* which define the whiteness/brightness (L*) and color (a*,b*) of the surface under examination. L* relates to the degree of brightness or darkness of the sample with 100 being very bright and zero being very dark. Although the PECPs can be tailored to possess a wide range of whiteness, usually the whiteness value L ranges from about 20 to about 95.

The efficiency-in-use of PECP can be influenced in at least two aspects. The first aspect relates to the efficiency of the intra-networking of the antimony-containing tin oxide crystallites on the surface of individual ECP particles. The second aspect relates to the efficiency relating of the inter-networking between ECP particles. The latter aspect is caused by particle-to-particle contact which is a function of particle morphology and orientation. The intermingling of multi-core ECP powders in the component particles results in better than predicted properties, such as electrical conductivity, transparency and degree of whiteness, compared with the weighted average of the individual types of ECP powder.

Another advantage of multi-core PECP compositions compared with the individual ECP components is that, for any particular level of electroconductivity, coatings containing the former can have substantially higher whiteness/brightness values (L*). This is very desirable in many applications particularly in ESD treatments for clothing and decorative materials.

The compositions of the invention have surprising benefits over conventionally used single component materials which are used to produce electroconductive properties in non-conducting materials. For example, carbon black is widely used for this purpose but opacity and dark color are often undesirable. White, transparent or lightly colored products with surface resistivities in the 10³ to 10¹² ohms/square range are easily achievable by using the PECP compositions of the invention. Also conductivity can be easily controlled and tailored for a desired range by using the PECPs of the invention.

The compositions of the invention are particularly useful in a variety of applications such as an ingredient in electrically conductive coatings, e.g., paints, varnishes, inks, plastic coatings such as fluoropolymer coatings, among other coatings. The PECPs can also be incorporated into or applied onto conventional paper formulations for imparting dielectric properties, and fibers, films, foams, solid containers and packing materials for providing electrostatic discharge (ESD) resistance or protection.

In yet another aspect, the compositions of the invention may be ideal for use in currency (e.g. money) applications. Modern currency manufacturing includes the use of paper materials, thermoplastic materials, and combinations thereof. Most particularly, the use of thermoplastic materials often results in the undesirable creation of static electricity during the manufacturing process. The inclusion of small amounts of ECPs can help reduce and/or eliminate this problem. However, current ECPs have the disadvantage of exhibiting some discoloration, such as a dark blue gray color, which affects the final coloration of the currency (or other end-use product). The present invention overcomes this problem by exhibiting more of a white color (i.e. less blue gray discoloration) which allows the currency manufacturer to be less restricted with the final coloration of the currency (or other end-use product). Without being bound by theory, it is believed that the presence of antimony causes the discoloration in the end-use product, as least in part. Because the ECPs of the present invention contain less antimony, but still provide substantially the same or even improved conductivity over current ECPs, they are a much needed improvement over the prior art.

While particular emphasis has been placed upon binary PECP mixtures, the PECPs of the invention can be multicomponent mixtures. By selecting the appropriate PECP components, the PECP can be tailored to possess a virtually unlimited array of characteristics, e.g., color, resistivity, transparency, cost effectiveness, among other characteristics.

The PECP compositions of the invention, methods of preparation and evaluation are demonstrated in the following examples for the purpose of providing more detailed information and illustrating the advantages of the present invention over the current state of the art. The following Examples are provided for illustration purposes only and are not to be construed as limiting in any way the scope of the invention as defined by the appended claims.

The following examples further illustrate the subject matter described above but, of course, should not be construed as in any way limiting the scope thereof.

### Example 1

### 1610-S and 1410-T Blend Formulation in Lab—0.5% Loading SbCl₃

### Preparation:

| Equipment | | Materials |
|---|---|---|
| 2 Liter RB flask | Analytical balance | 30% NaOH |
| Overhead agitator | Glass bowl | 30% HCL |
| Glass stir rod | 1000 mL flask | DI water |
| pH meter | Filter | CaCO₃ |
| Automatic pump | Filter paper | Kasil #6 |
| Temperature gauge | Air pump | CaCl |
| (5) 400 mL beakers | Ceramic bowl | Antimony trichloride |
| (2) 800 mL beakers | Oven | Tin chloride |
| Liquid conductivity meter | Presser | Titanium dioxide |
| Surface conductivity meter | Masterflex L/S | |
| | pump with #13 | |
| | tubing | |

### Stock Solutions

Solution A: In 250 ml or greater Erlenmeyer flask was charged 18.23 g deionized (“DI”) water+65.35 g Kasil #6 (potassium silicate mix).

### Solution B

Part 1: Into a small beaker was charged 58.2 g DI water+78.03 g CaCl₂ (dissolved).
Part 2 In a separate 250 ml flask was charged 99.75 g DI water+20.4 g 30% HCL (converted for normality) or order 30% HCL (mix).
Part 3: Part 1 was added to part 2 and mixed=Solution B.

### Procedure:

This was a 3 to 4 day procedure.

### Day One:

500 g of DI water was added to an overhead mixer equipped RB 2 liter flask (five neck). The pH was adjusted to 9.5 by means of pipette of NaOH. Mixture was heated to 80° C. Mixture was agitated at 300 RPMs. 36.3 g of CaCO₃ (calcium carbonate) was added to the mixture. The pH was adjusted to 9.5 by means of pipette of NaOH. 66.7 g of TiO₂ was then added to the reactor. The pH was adjusted to 10 by means of micro pipette of NaOH.

Solution A was slowly added (Time=0) to the stirring RB flask (CaCO₃/TiO₂/water solution w/ temperature and pH probes) over a 2-3 hour period of time until the mixture was exhausted. The pump speed was set at approximately 0.9+/−mL/min. pH readings were taken every 10 minutes, and the pH was adjusted using Solution B. The target pH=9.5 for the first hour or hour and a half of the reaction. The measurements are provided in Table 1A.

When Solution A's addition was completed, the mixture was held under agitation for 1 hour at pH=9.5 and 80° C. The pH was lowered to 7.0-7.5 by adding the remainder of Solution B and additional diluted 30% HCL (add 4 grams of H₂O to 1 gram of 30% HCL stock solution) with the pump speed set at 1.1 mL/min.

After pH was stable at desired pH of 7.0, the solution was held for 45 minutes. The heat was turned off and 750 mL of DI water was added under continuous agitation. When the temperature dropped to less than 37° C., agitation was continued for 30 more minutes. Agitation was then turned off, and the mixture was allowed to settle overnight at room temperature.

The pH and temperature of the mixture was recorded on Day 1 and is displayed in Table 1A.

TABLE 1A
Day 1 pH and Temperature Recordings
During Addition of Solution A

| | Speed of | Speed of | |
|---|---|---|---|
| | Solution A | Solution B | pH Reading/ |
| Time Elapsed | Addition | Addition | Temp. |
| (minutes) | (mL/min) | (mL/min) | ° C. |
| 0 | 1.2 | 0.6 | 9.70/79.9 |
| 10 | 1.2 | 0.0 | 9.76/80.8 |
| 20 | 1.0 | 0.0 | 9.01/79.8 |
| 30 | 1.0 | 0.6 | 9.0/79.8 |
| 40 | 1.2 | 0.0 | 9.56/80.4 |
| 50 | 1.2 | 0.6 | 9.95/80.0 |
| 60 | 1.2 | 0.0 | 9.25/78.4 |
| 70 | 1.1 | 0.6 | 9.99/80.4 |
| 80 | 1.1 | 0.6 | 9.08/80.1 |
| 90 | 1.1 | 0.6 | 9.23/79.8 |
| 100 | 0.6 | 0.0 | 9.53/80.1 |

### Day Two:

The clear layer of the mixture was decanted off by means of the pump and discarded. The approximate yield of decant was 700-750 mL. The remaining mixture in the flask was heated to 80° C. under agitation. Solution C was prepared.

### Solution C:

Part 1: In 250 ml flask was charged 189.3 g of 50% tin chloride solution. Mixing was initiated with a magnetic stir bar and then 28.4 g of DI water was also added to the flask.
Part 2: In a separate dry flask was charged 0.88325 g of antimony trichloride crystals, followed by 47.3 g of 37% HCL concentrate.
Part 3: Part 2 was added to Part 1 and mixed=Solution C.

30% HCL was slowly added over a 2 hour period to lower the pH to 1. Pump speed was set at 1.2 mL/min. When pH reached approximately 4-5, addition of the HCL solution was paused for about 15 minutes while only stirring. When the pH reached 2.5, the addition of HCL was slowed to 0.6 mL/min.

At pH=1, 750 ml of DI water was added and agitation occurred for 30 minutes. Then, while maintaining pH of 1, the heat was turned off. The mixture was allowed to settle and was then followed by decanting the 750 ml of water.

The pH and temperature of the mixture during the HCL addition was recorded on Day 2 and is displayed in Table 1B.

TABLE 1B
Day 2 pH and Temperature Recordings
During Addition of 30% HCL

| | Speed of | |
|---|---|---|
| Time Elapsed | HCL Addition | pH Reading/ |
| (minutes) | (mL/min) | Temp ° C. |
| 0 | 0.8 | 7.46/80.6 |
| 10 | 0.7 | 6.92/81.6 |
| 20 | 0.7 | 6.43/80.0 |
| 30 | 0.6 | 5.47/79.6 |
| 40 | 0.6 | 5.25/80.6 |
| 50 | 0.6 | 5.19/79.9 |
| 60 | 0.7 | 5.14/79.6 |
| 70 | 0.7 | 4.98/80.2 |
| 100 | 0.7 | 4.98/80.2 |
| 110 | 0.7 | 4.44/80.1 |
| 120 | 0.7 | 4:40/80.3 |
| 140 | 0.7 | 3.00/80.1 |
| 150 | 0.7 | 2.89/79.9 |
| 160 | 0.6 | 2.53/79.8 |
| 170 | 0.8 | 1.85/80.1 |

The pH was slowly raised to pH=2 by means of NaOH at pump speed of 0.9 mL/min. The pH was stabilized at pH=2. Solution C was then charged to the reactor to exhaust over a 2 hour period while maintaining pH=2 with 30% NaOH. The pump speed of the Solution C addition was approximately 1.5 mL/min. The pH of 1.8-2.2 was maintained by means of the 30% NaOH.

When Solution C was exhausted, the pH was held at 1.8-2.2 with agitation for 45 minutes at 80° C. The mixture was then allowed to cool overnight.

The pH and temperature of the mixture was recorded during the Solution C addition on Day 2 and is displayed in Table 1C.

TABLE 1C
Day 2 pH and Temperature Recordings
During Addition of Solution C

| | Speed of 30% | Speed of Solution | |
|---|---|---|---|
| Time Elapsed | NaOH Addition | C Addition | pH Reading/ |
| (Minutes) | (mL/min) | (mL/min) | Temp. ° C. |
| 0 | 1.8 | 1.3 | 2.22/80.7 |
| 10 | 1.3 | 1.0 | 2.71/80.8 |
| 20 | 1.3 | 1.0 | 1.80/79.9 |
| 30 | 1.5 | 1.0 | 1.89/80.3 |
| 40 | 1.7 | 1.1 | 1.88/79.7 |
| 50 | 1.5 | 1.3 | 2.0/79.7 |
| 60 | 1.5 | 1.3 | 2.0/79.7 |
| 70 | 1.5 | 1.3 | 2.0/79.7 |
| 80 | 1.5 | 1.3 | 2.10/80.3 |
| 90 | 1.6 | 1.3 | 2.08/79.9 |
| 100 | 1.5 | 1.3 | 1.90/80.0 |
| 110 | 1.5 | 1.3 | 1.99/79.8 |
| 120 | 1.7 | 1.3 | 1.99/79.8 |
| 130 | 1.8 | 1.5 | 2.22/80.2 |
| 140 | 1.8 | 1.5 | 2.23/80.3 |

### Day Three:

The cooled mixture (the filtrate or solid) was transferred to a filter and washed. DI water was used sparingly during the first wash. Conductivity measurements of the filtrate were taken after the first wash. If conductivity reading was above 4 micro Siemens (“μS”), then the wash was repeated with 400 mL of fresh DI water until 4 μS was reached (using fresh DI water for every washing).

The solid was then transferred to a ceramic bowl and calcined for 2 hours at 750° C. (furnace was set to heat to 750° C. over 3 hours and to cook for 2 hours).

The calcined powder was then tested for conductivity using a tablet press machine. Approximately 5 g of powder was placed in a clear cylinder. It was pressed at 2 psi. Resistivity was recorded. The length of the compact powder was recorded and the following equation was used to determine resistivity of the powder:

$$E = \frac{R \times a}{e}$$

E=powder resistivity in ohm×cm
e=length in cell (cm)
R=resistivity
a=area of inert=7.76 cm²

The dry powder resistivity of Example 1 was calculated as follows:

33.99×7.76/0.7=376.8 ohms per cm.

### Example 2

### 1610-S and 1410-T Blend Formulation in Lab—1% Loading SbCl₃

Example 1 was repeated, except that 1.7665 g of antimony trichloride crystals were used.

The pH and temperature of the mixture was recorded on Day 1 and is displayed in Table 2A.

TABLE 2A
Day 1 pH and Temperature Recordings
During Addition of Solution A

| | Speed of Solution | Speed of Solution | |
|---|---|---|---|
| Time Elapsed | A Addition | B Addition | pH Reading/ |
| (minutes) | (mL/min) | (mL/min) | Temp. ° C. |
| 0 | 0.9 | 0.6 | 9.24/85.5 |
| 10 | 0.9 | 0.0 | 9.15/79.9 |
| 20 | 0.9 | 0.6 | 9.19/79.5 |
| 30 | 0.9 | 0.6 | 9.25/80.1 |
| 40 | 0.9 | 0.6 | 9:10/80.2 |
| 50 | 0.9 | 0.6 | 9.75/79.7 |
| 60 | 0.9 | 0.6 | 9.00/80.1 |
| 60 | 0.9 | 0.6 | 9.00/80.3 |
| 70 | 0.9 | 0.6 | 9.15/79.9 |
| 80 | 0.9 | 0.6 | 9.43/80.0 |
| 90 | 0.9 | 0.6 | 9.00/80.1 |
| 100 | 0.9 | 0.6 | 9.00/80.1 |
| 110 | 0.9 | 0.6 | 9.00/81.3 |
| 120 | 0.9 | 0.6 | 9.00/81.2 |

The pH and temperature of the mixture during the HCL addition was recorded on Day 2 and is displayed in Table 2B.

TABLE 2B
Day 2 pH and Temperature Recordings
During Addition of 30% HCL

| | Speed of | |
|---|---|---|
| Time Elapsed | HCL Addition | pH Reading/ |
| (minutes) | (mL/min) | Temp ° C. |
| 0 | 0.8 | 7.27 |
| 15 | 0.6 | 6.48 |
| 30 | 0.6 | 6.14 |
| 45 | 0.6 | 5.63 |
| 60 | 0.6 | 5.49 |
| 75 | 0.6 | 5.37 |
| 90 | 0.6 | 5.23 |
| 105 | 0.8 | 4.97 |
| 120 | 0.8 | 4.65 |
| 135 | 0.8 | 3.98 |

The pH and temperature of the mixture was recorded during the Solution C addition on Day 2 and is displayed in Table 2C.

TABLE 2C
Day 2 pH and Temperature Recordings
During Addition of Solution C

| | Speed of 30% | Speed of Solution | |
|---|---|---|---|
| Time Elapsed | NaOH Addition | C Addition | pH Reading/ |
| (Minutes) | (mL/min) | (mL/min) | Temp. ° C. |
| 0 | 0.9 | 1.0 | 1.88/83.0 |
| 10 | 0.9 | 1.0 | 1.89/82.0 |
| 20 | 0.9 | 1.0 | 1.99/79.3 |
| 30 | 0.9 | 1.0 | 1.81/79.7 |
| 40 | 0.9 | 1.0 | 2.12/80.5 |
| 50 | 0.9 | 1.0 | 2.30/79.8 |
| 60 | 0.9 | 1.0 | 2.00/79.6 |
| 70 | 0.9 | 1.0 | 2.10/80.0 |
| 80 | 0.9 | 1.0 | 2.28/79.4 |
| 100 | 0.9 | 1.0 | 1.58/80.3 |
| 110 | 0.9 | 1.0 | 2.20/80.5 |
| 120 | 0.9 | 1.0 | 2.20/80.4 |
| 150 | 0.9 | 1.0 | 1.78/80.2 |

The dry powder resistivity of Example 2 was calculated as follows:

98.4 ohms×7.76 cm²/0.4 cm=1908.96 ohms per cm.

### Example 3

### 1610-S and 1410-T Blend Formulation in Lab—3% Loading SbCl₃

Example 1 was repeated, except that 3.533 g of antimony trichloride crystals were used.

The pH and temperature of the mixture was recorded on Day 1 and is displayed in Table 3A.

TABLE 3A
Day 1 pH and Temperature Recordings
During Addition of Solution A

| | Speed of Solution | Speed of | |
|---|---|---|---|
| Time Elapsed | A Addition | HCL Addition | pH Reading/ |
| (minutes) | (mL/min) | (mL/min) | Temp. ° C. |
| 0 | 1.2 | 0.0 | 9.53/79.8 |
| 10 | 1.2 | 0.0 | 9.74/80.4 |
| 20 | 1.2 | 0.6 | 9.68/80.1 |
| 30 | 1.2 | 0.0 | 9.68/80.5 |
| 40 | 1.2 | 0.0 | 9.93/80.2 |
| 50 | 1.2 | 0.6 | 9.00/79.6 |
| 60 | 1.2 | 0.0 | 9.54/80.1 |
| 70 | 1.2 | 0.0 | 9.58/79.7 |
| 80 | 1.2 | 0.6 | 9.62/81.2 |
| 90 | 1.2 | 0.0 | 9.50/80.0 |
| 100 | 1.2 | 0.0 | 9.48/80.0 |
| 110 | 1.2 | 0.0 | 9.54/80.2 |
| 120 | 1.2 | 0.0 | 9.69/80.1 |
| 130 | 1.2 | 0.0 | 9.58/81.2 |
| 140 | 1.2 | 0.0 | 9.42/81.3 |

The pH and temperature of the mixture during the HCL addition was recorded on Day 2 and is displayed in Table 3B.

TABLE 3B
Day 2 pH and Temperature Recordings
During Addition of 30% HCL

| | Speed of | |
|---|---|---|
| Time Elapsed | HCL Addition | pH Reading/ |
| (minutes) | (mL/min) | Temp ° C. |
| 0 | 1.0 | 7.37/81.3 |
| 10 | 0.6 | 6.72/79.9 |
| 20 | 0.6 | 6.36/79.8 |
| 30 | 0.6 | 5.85/80.4 |
| 40 | 0.6 | 5.31/79.6 |
| 50 | 0.6 | 5.24/80.0 |
| 60 | 0.6 | 5.19/80.0 |
| 70 | 0.6 | 5.05/79.9 |
| 80 | 0.6 | 4.98/79.8 |
| 90 | 1.2 | 4.50/80.0 |
| 105 | 0.6 | 4.61/80.4 |
| 115 | 1.2 | 4.38/80.0 |
| 125 | 1.2 | 3.98/81.2 |
| 135 | 1.2 | 3.54/81.3 |
| 145 | 1.2 | 2.58/82.0 |

The pH and temperature of the mixture was recorded during the Solution C addition on Day 2 and is displayed in Table 3C.

TABLE 3C
Day 2 pH and Temperature Recordings
During Addition of Solution C

| | Speed of 30% | Speed of Solution | |
|---|---|---|---|
| Time Elapsed | NaOH Addition | C Addition | pH Reading/ |
| (Minutes) | (mL/min) | (mL/min) | Temp. ° C. |
| 0 | 1.0 | 1.0 | 1.88/80.9 |
| 10 | 1.3 | 1.0 | 2.23/78.8 |
| 20 | 1.2 | 1.0 | 1.88/79.1 |
| 30 | 1.2 | 1.0 | 1.85/80.5 |
| 40 | 1.2 | 1.0 | 1.91/79.7 |
| 50 | 1.2 | 1.0 | 1.92/79.6 |
| 60 | 1.2 | 1.0 | 1.96/80.2 |
| 70 | 1.2 | 1.0 | 2.10/80.1 |
| 80 | 2.4 | 2.0 | 2.10/80.1 |
| 90 | 2.4 | 2.0 | 1.88/80.0 |
| 100 | 2.4 | 2.0 | 2.20/80.5 |
| 110 | 2.4 | 2.0 | 2.19/79.9 |

The dry powder resistivity of Example 3 was calculated as follows:

ohms×7.76 cm²/0.6 cm=62.08 ohms per cm.

### Example 4

### 1610-S and 1410-T Blend Formulation in Lab—5% Loading SbCl₃

Example 1 was repeated, except that 5.3 g of antimony trichloride crystals were used.

The pH and temperature of the mixture was recorded on Day 1 and is displayed in Table 4A.

TABLE 4A
Day 1 pH and Temperature Recordings
During Addition of Solution A

| | Speed of Solution | Speed of | |
|---|---|---|---|
| Time Elapsed | A Addition | HCL Addition | pH Reading/ |
| (minutes) | (mL/min) | (mL/min) | Temp. ° C. |
| 0 | 0.9 | 0.6 | 9.24/85.5 |
| 10 | 0.9 | 0.0 | 9.15/79.9 |
| 20 | 0.9 | 0.6 | 9.19/79.5 |
| 30 | 0.9 | 0.6 | 9.25/80.1 |
| 40 | 0.9 | 0.6 | 9:10/80.2 |
| 50 | 0.9 | 0.6 | 9.75/79.7 |
| 60 | 0.9 | 0.6 | 9.00/80.1 |
| 60 | 0.9 | 0.6 | 9.00/80.3 |
| 70 | 0.9 | 0.6 | 9.15/79.9 |
| 80 | 0.9 | 0.6 | 9.43/80.0 |
| 90 | 0.9 | 0.6 | 9.00/80.1 |
| 100 | 0.9 | 0.6 | 9.00/80.1 |
| 110 | 0.9 | 0.6 | 9.00/81.3 |
| 120 | 0.9 | 0.6 | 9.00/81.2 |

The pH and temperature of the mixture during the HCL addition was recorded on Day 2 and is displayed in Table 4B.

TABLE 4B
Day 2 pH and Temperature Recordings
During Addition of 30% HCL

| | Speed of | |
|---|---|---|
| Time Elapsed | HCL Addition | pH Reading/ |
| (minutes) | (mL/min) | Temp ° C. |
| 0 | 0.8 | 7.27 |
| 15 | 0.6 | 6.48 |
| 30 | 0.6 | 6.14 |
| 45 | 0.6 | 5.63 |
| 60 | 0.6 | 5.49 |
| 75 | 0.6 | 5.37 |
| 90 | 0.6 | 5.23 |
| 105 | 0.8 | 4.97 |
| 120 | 0.8 | 4.65 |
| 135 | 0.8 | 3.98 |

The pH and temperature of the mixture was recorded during the Solution C addition on Day 2 and is displayed in Table 4C.

TABLE 4C
Day 2 pH and Temperature Recordings
During Addition of Solution C

| | Speed of 30% | Speed of Solution | |
|---|---|---|---|
| Time Elapsed | NaOH Addition | C Addition | pH Reading/ |
| (Minutes) | (mL/min) | (mL/min) | Temp. ° C. |
| 0 | 0.9 | 1.0 | 1.88/83.0 |
| 10 | 0.9 | 1.0 | 1.89/82.0 |
| 20 | 0.9 | 1.0 | 1.99/79.3 |
| 30 | 0.9 | 1.0 | 1.81/79.7 |
| 40 | 0.9 | 1.0 | 2.12/80.5 |
| 50 | 0.9 | 1.0 | 2.30/79.8 |
| 60 | 0.9 | 1.0 | 2.00/79.6 |
| 70 | 0.9 | 1.0 | 2.10/80.0 |
| 80 | 0.9 | 1.0 | 2.28/79.4 |
| 100 | 0.9 | 1.0 | 1.58/80.3 |
| 110 | 0.9 | 1.0 | 2.20/80.5 |
| 120 | 0.9 | 1.0 | 2.20/80.4 |
| 150 | 0.9 | 1.0 | 1.78/80.2 |

The dry powder resistivity of Example 4 was calculated as follows:

0.7×7.76 cm/0.7 cm=7.76 ohms per cm.

### Example 5

### 1610-S and 1410-T Blend Formulation in Lab—10% Loading SbCl₃

Example 1 was repeated, except that 10.6 g of antimony trichloride crystals were used. In addition, due to issues with the furnace, the wash and calcining steps were performed on Day Four.

The pH and temperature of the mixture was recorded on Day 1 and is displayed in Table 5A. The color of the mixture was also recorded in Table 5A.

TABLE 5A
Day 1 pH and Temperature Recordings
During Addition of Solution A

| | Speed of Solution | Speed of | |
|---|---|---|---|
| Time Elapsed | A Addition | HCL Addition | pH Reading/ |
| (minutes)/Color | (mL/min) | (mL/min) | Temp. ° C. |
| 0/white | 1.2 | 0.0 | 9.66/81.4 |
| 10/white | 1.2 | 0.0 | 9.82/79.0 |
| 20/white | 1.2 | 0.0 | 9.98/79.9 |
| 20/white | 1.2 | 0.0 | 9.87/79.8 |
| 30/white | 1.2 | 0.0 | 10.05/80.0 |
| 40/white | 1.2 | 0.0 | 9.00/80.2 |
| 50/white | 1.2 | 0.6 | 10.05/79.9 |
| 60/white | 1.2 | 0.0 | 10.00/80.0 |
| 70/white | 1.0 | 0.0 | 9.35/80.0 |
| 80/white | 1.0 | 0.6 | 9.71/80.2 |
| 90/white | 1.0 | 0.0 | 9.73/80.2 |
| 100/white | 1.0 | 0.0 | 9.67/79.8 |
| 110/white | 1.0 | 0.0 | 9.67/79.8 |

The pH and temperature of the mixture during the HCL addition was recorded on Day 2 and is displayed in Table 5B.

TABLE 5B
Day 2 pH and Temperature Recordings
During Addition of 30% HCL

| | Speed of | |
|---|---|---|
| Time Elapsed | HCL Addition | pH Reading/ |
| (minutes) | (mL/min) | Temp ° C. |
| 0 | 1.0 | 7.30/82.5 |
| 10 | 1.0 | 6.80/82.7 |
| 20 | 1.0 | 6.41/81.3 |
| 30 | 1.0 | 4.72/78.9 |
| 60 | 0.8 | 5.45/80.4 |
| 70 | 0.8 | 4.80/79.4 |
| 80 | 0.8 | 4.77/80.2 |
| 90 | 0.8 | 4.75/80.1 |
| 100 | 1.0 | 4.00/80.0 |
| 110 | 1.0 | 3.87/79.9 |
| 120 | 0.6 | 1.10/80.0 |
| 130 | 0.6 | 1.07/79.9 |

The pH and temperature of the mixture was recorded during the Solution C addition on Day 2 and is displayed in Table 5C. The color of the mixture was also recorded in Table 5C.

TABLE 5C
Day 2 pH and Temperature Recordings
During Addition of Solution C

| | Speed of 30% | Speed of Solution | |
|---|---|---|---|
| Time Elapsed | NaOH Addition | C Addition | pH Reading/ |
| (Minutes)/Color | (mL/min) | (mL/min) | Temp. ° C. |
| 0/white | 1.0 | 1.1 | 1.88/83.0 |
| 10/white | 1.0 | 0.0 | 1.89/82.0 |
| 20/white | 1.0 | 1.2 | 1.99/79.3 |
| 30/white | 2.4 | 1.2 | 1.81/79.7 |
| 40/off white | 2.3 | 1.5 | 2.12/80.5 |
| 50/beige | 2.3 | 1.5 | 2.30/79.8 |
| 60/tan | 2.3 | 1.5 | 2.00/79.6 |
| 70/tan | 2.3 | 1.5 | 2.10/80.0 |
| 80/tan | 2.3 | 1.5 | 2.28/79.4 |
| 90/tan | 2.3 | 1.5 | 1.58/80.3 |
| 100/tan | 2.3 | 1.5 | 2.20/80.5 |
| 110/tan | 2.3 | 1.5 | 2.20/80.4 |

The dry powder resistivity of Example 5 was calculated as follows:

0.4×7.76 cm/0.5 cm=6.208 ohms per cm.

### Conductivity Testing

| Equipment | Materials |
|---|---|
| Overhead Mixer | Examples 1 to 5 |
| Cowles Mixing Blade | Binder: BEHR-White Paint- |
| Draw Down Instrument | 1 part epoxy-acrylic, |
| Wire Size #20, (2.0 Mils -50.8 microns) | garage floor paint |
| Anti-Static Transparency Sheets | |
| (Polyester Layout Base: A/S Poly 2 sides, | |
| clear, size: 8.5″ × 11″) | |
| Wire brush for clean up | |
| Tongue depressors | |
| Jumbo pipets | |
| ACL Staticide Specialists in Static Control | |
| Model 385 Resistivity Meter | |
| (4) 600 mL plastic beakers | |

### Procedure:

Examples 1-5 were individually combined with a commercially available paint and tested for conductivity according to the following procedure.

21.63 grams of each sample was added to a plastic beaker. 78.37 grams of Behr paint was then added to the plastic beaker. The two components were combined using a tongue depressor. The mixture was then agitated for 25-35 minutes using an overhead mixer. A transparency sheet was then labeled and attached to the draw down machine. Approximately 6.5 grams of the mixture was added to draw down wire bar #20 (2.0 mils-50.8 microns) to be drawn down. Draw down occurred. The mixture was avowed to dry on the sheet, and then the coated transparency sheet was tested for conductivity. The results are provided in Table 6.

TABLE 6
Resistivity Readings and Visual Observations for In-Situ
Blends of ECP at 40% Solids at Various Concentrations

| | Resistivity | |
|---|---|---|
| Sample | (Ohms/sq) | Visual Observations |
| 10% ECP | 10⁴ | Coating is dark blue gray and very |
| | | uniformed. |
| 5% ECP | 10⁵ | Coating is light blue gray and very |
| | | uniformed. |
| 3% ECP | 10⁵ | Coating is ivory and very uniformed. |
| 1% ECP | 10⁵ | Coating is white with glomerates. |
| 0.5% ECP | 10¹⁰ | Coating is white with glomerates. |

FIG. 1A shows a photomicrograph of a manual blend of ECP-T and ECP-S creating a PECP. In this figure one can see that there are two distinct particles corresponding to the two different materials that are being blended together. This is further detailed by FIG. 1B showing the gas chromatography scans of the two unique particles. Gas chromatography of Particle A shows that it is ECP-S and gas chromatography of particle B shows that it is ECP-T. This confirms that the resulting PECP produced through a blend process still maintains discreet, individual particles.

FIG. 2B shows a photomicrograph of an in-situ synthesized dual core PECP (T and S based). In this figure one can see that all particles appear similar in nature, unlike FIG. 1A. This is further detailed by FIGS. 3A-3E which are gas chromatography scans of several of the particles. These gas chromatography scans show the same relative amounts of Ti and Si in each particle which one would expect when the dual cores are synthesized rather than manually blended. This confirms that this is a new type of PECP versus the PECP prepared through a blending process.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A multi-core electroconductive composition comprising at least two core materials.

2. The electroconductive composition of claim 1 wherein the at least two core materials are independently selected from the group consisting of mica; silica; calcium carbonate; oxides of titanium, magnesium, calcium, barium, strontium, zinc, tin, nickel and iron; barium carbonate; strontium carbonate; calcium sulfate; barium sulfate; strontium sulfate, cordierite; anorthite; and pyrophyllite.

3. The electroconductive composition of claim 1 comprising a mixture of A) particles of an electroconductive powder comprising antimony-containing tin oxide and B) separate particles of a non-electrically conducting filler selected from the group consisting of silica, titanium dioxide, mica, calcium carbonate, and mixtures thereof, in a ratio of electroconductive powder to non-electrically conducting filler of from about 98:2 to about 7:3, said mixture possessing a dry powder resistivity which is lower than the weighted average of its components.

4. The electroconductive composition of claim 3 wherein said electroconductive powder comprises a conducting coating of antimony-containing tin oxide on the at least two core materials.

5. The electroconductive composition of claim 3 wherein the electroconductive powder is selected from the group consisting of crystallites of antimony-containing tin oxide, metal coated powders and two dimensional networks of crystallites of antimony-containing tin oxide in association with amorphous silica or silica-containing material.

6. The electroconductive composition of claim 3 wherein the non-electrically conductive filler is selected from the group consisting of calcium carbonate; silica; mica; oxides of titanium, magnesium, calcium, barium, strontium, zinc, tin, nickel and iron; barium carbonate; strontium carbonate; calcium sulfate; barium sulfate; strontium sulfate, cordierite; anorthite; and pyrophyllite.

7. The electroconductive composition of claim 3 wherein the antimony content is less than about 12.5% by weight of tin oxide.

8. The electroconductive composition of claim 3 wherein the dry powder resistivity of said mixture is at least 5% lower than the weighted average dry powder resistivity of the components.

9. The electroconductive composition of claim 3 wherein the transparency of said mixture is at least about 3% greater than the transparency of said individual components of the mixture.

10. The electroconductive composition of claim 3 wherein said mixture comprises hollow shells of amorphous silica having a surface coating layer of antimony-containing tin oxide and a silica coated solid core of titanium dioxide covered with a conductive coating of antimony-containing tin oxide.

11. The electroconductive composition of claim 1 wherein the composition is dispersed in or applied onto a matrix material selected from the group consisting of paints, varnishes, inks, plastics, and paper.

12. The electroconductive composition of claim 1 wherein the composition is dispersed in or applied onto a thermoplastic material.

13. A form of monetary currency comprising the composition of claim 1.
